(19) United States
(12) Patent Application Publication
(10) Pub. No.: US 2015/0110191 A1
(43) Pub. Date: Apr. 23, 2015

(54) VIDEO ENCODING METHOD AND APPARATUS, AND VIDEO DECODING METHOD AND APPARATUS PERFORMING MOTION COMPENSATION

(71) Applicants: Jung-yeop Yang, Seoul (KR); Nyeong-kyu Kwon, Daejeon (KR)

(72) Inventors: Jung-yeop Yang, Seoul (KR); Nyeong-kyu Kwon, Daejeon (KR)

(21) Appl. No.: 14/515,905

(22) Filed: Oct. 16, 2014

(30) Foreign Application Priority Data
Oct. 21, 2013 (KR) 10-2013-0125547

(51) Int. Cl. H04N 19/523; H04N 19/51

(52) U.S. Cl. CPC H04N 19/0063; H04N 19/00696
USPC 375/240.16

(57) ABSTRACT

A video encoding method includes detecting properties of pixels included in a prediction block, dividing the prediction block into at least two regions according to a result of detecting the properties of the pixels, calculating offset values respectively for the at least two regions, according to a result of dividing the prediction block, and generating an offset prediction block by applying the offset values calculated respectively for the at least two regions to pixel values of the pixels in the prediction block.

### CROSS-REFERENCE TO RELATED APPLICATIONS

This U.S. non-provisional application claims priority under 35 U.S.C. §119 to Korean Patent Application No. 10-2013-0125547, filed on Oct. 21, 2013, in the Korean Intellectual Property Office, the contents of which are herein incorporated by reference in their entirety.

### BACKGROUND

The example embodiments of the present inventive concepts relate to a video encoding method and apparatus and a video decoding method and apparatus. More particularly, the example embodiments of the present inventive concepts relate to a video encoding method and apparatus and a video decoding method and apparatus for improving compression efficiency.

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on a macroblock having a predetermined size.

Image data of a spatial domain is transformed into coefficients of a frequency domain via frequency transformation. According to a video codec, an image is split into blocks having a predetermined size, discrete cosine transformation (DCT) is performed on each block, and frequency coefficients are encoded in block units, for rapid calculation of frequency transformation. Unlike the image data of a spatial domain, coefficients of a frequency domain are easily compressed. Since an image pixel value of a spatial domain is expressed according to a prediction error via inter prediction or intra prediction of a video codec, compression efficiency needs to be improved by reducing the prediction error.

### SUMMARY

The example embodiments of the present inventive concepts provide a video encoding method and apparatus for improving a compression efficiency of a video that is encoded via motion estimation and compensation, and a video decoding method and apparatus.

According to an aspect of the present inventive concepts, there is provided a video encoding method including: detecting properties of pixels included in a prediction block; dividing the prediction block into at least two regions according to a result of detecting the properties of the pixels; calculating offset values respectively for the at least two regions, according to a result of dividing the prediction block; and generating an offset prediction block by applying the offset values calculated respectively for the at least two regions to pixel values of the pixels in the prediction block.

In some embodiments, the video encoding method may further include performing an interpolation filtering operation on integer pixel values in order to generate a prediction block of a sub-pixel unit in addition to the prediction block of an integer pixel unit.

In some embodiments, the detecting of the properties of the pixels may include detecting at least one of a brightness and an edge characteristic of each of the pixels included in the prediction block.

In some embodiments, the dividing of the prediction block into the at least two regions may include: classifying classes to which the pixels included in the prediction block belong according to the properties of the pixels; and setting pixels that belong to the same class or similar classes as a region of the at least two regions according to a result of classifying the classes.

In some embodiments, the prediction block may include a first pixel included in a first region and a second pixel included in a second region, and the generating of the offset prediction block may include adding a first offset value to the first pixel and adding a second offset value to the second pixel.

In some embodiments, the prediction block may include first through nth regions (here, n is an integer equal to or greater than 2), and the calculating of the offset values may include calculating first through nth offset values corresponding to the first through nth regions, respectively.

In some embodiments, the offset prediction block may be generated by adding the first through nth offset values respectively to the pixels included in the first through nth regions, and the video encoding method may further include: calculating a difference value between a pixel value of an original image and a pixel value of the offset prediction block; and performing a transformation operation by using a result of calculating the difference value.

In some embodiments, the video encoding method may further include performing motion estimation by using a current frame and a reference frame, in order to generate the prediction block.

According to another aspect of the present inventive concepts, there is provided a video decoding method including: parsing a plurality of offset values included in a bitstream; generating a prediction block based on a motion vector; dividing the prediction block into a plurality of regions according to properties of pixels included in the prediction block; and generating an original block corresponding to the prediction block by applying the plurality of offset values that are different for each of the plurality of regions to pixels included in different regions of the prediction block.

In some embodiments, a first offset value and a second offset value are parsed from the bitstream, and the prediction block comprises a first region and a second region, and the generating of the original block comprises adding the first offset value to pixel values of pixels included in the first region of the prediction block and adding the second offset value to pixel values of pixels included in the second region of the prediction block.

In some embodiments, the vide decoding method further includes performing an interpolation filtering operation by using integer pixel values in order to generate a prediction block of a sub-pixel unit that is different from a location of an integer pixel.

In some embodiments, the dividing of the prediction block into the plurality of regions includes determining at least one of a brightness and an edge characteristic of each of the pixels in the prediction block; and classifying classes to which each of the pixels belongs according to a result of determining at least one of a brightness and an edge characteristic of each of the pixels in the prediction block.

In some embodiments, the dividing of the prediction block into the plurality of regions further comprises setting pixels included in the same or similar classes in a same region according to a result of classifying the classes.

In some embodiments, the generating of the original block includes generating a first calculation result by adding a pixel value of each pixel in the prediction block to a corresponding offset value; and generating a second calculation result by adding residue data information included in the bitstream to the first calculation result.

In some embodiments, the bitstream further includes first information representing whether the offset values with respect to the regions will be applied or not, and the dividing of the prediction block into the plurality of regions may be selectively performed according to a status of the first information.

In some embodiments, the bitstream further comprises first information about a criterion for classifying the regions, and the dividing of the prediction block into the plurality of regions comprises detecting at least one property between a brightness level and an edge category of the pixels included in the prediction block based on the first information.

In some embodiments, the prediction block comprises first through nth regions (here, n is an integer equal to or greater than 2), and the offset values that are parsed comprise first through nth offset values corresponding respectively to the first through nth regions.

According to another aspect of the present inventive concepts, there is provided a video decoding apparatus performing a decoding operation after receiving a bitstream, the video decoding apparatus including a motion compensation unit including: a prediction block generator for generating a prediction block based on a motion vector included in the bitstream; a class divider for dividing the prediction block into a plurality of regions according to properties of pixels included in the prediction block; and a calculator for generating a motion compensation result through calculation processes using a plurality of offset values included in the bitstream and the pixels included in the prediction block.

In some embodiments, the class divider divides classes to which each of the pixels is included based on at least one of brightness levels and edge category characteristics of the pixels included in the prediction block.

In some embodiments, the motion compensation unit further comprises an offset value extractor for parsing the plurality of offset values included in the bitstream.

In some embodiments, the calculator adds values of the pixels included in the prediction block and offset values that are different from each other according to the plurality of regions in which the pixels are included.

According to another aspect of the present inventive concepts, there is provided an application processor including a video decoding apparatus performing a decoding operation after receiving a bitstream, the video decoding apparatus including a motion compensation unit including: a prediction block generator for generating a prediction block based on a motion vector included in the bitstream; a class divider for dividing the prediction block into a plurality of regions according to properties of pixels included in the prediction block; and a calculator for generating a motion compensation result through calculation processes using a plurality of offset values included in the bitstream and the pixels included in the prediction block.

According to an aspect of the inventive concept, there is provided a motion compensation method including: generating a prediction block corresponding to an original block based on a motion vector; dividing the prediction block into a plurality of regions according to properties of pixels included in the prediction block; and restoring the original block by applying different offset values to pixels included in the plurality of regions.

In some embodiments, the dividing of the prediction block into a plurality of regions comprises dividing the prediction block into two or more regions according to at least one of brightness levels and edge categories of the pixels, and the restoring of the original block comprises adding values of the pixels included in the plurality of regions to offset values corresponding to the plurality of regions.

In some embodiments, the motion compensation method further includes performing an interpolation filtering to generate a prediction block of a sub-pixel unit.

According to another aspect of the present inventive concepts, there is provided a motion compensation method including classifying a prediction block into a plurality of regions according to properties of pixels of the prediction block and calculating a plurality of offset values for each of the plurality of regions. The offset values of at least two of the plurality of offset values are different from each other.

In some embodiments, the classifying the prediction block into a plurality of regions comprises classifying the prediction block into two or more regions according to at least one of brightness levels and edge categories of the pixels.

In some embodiments, the classifying of the prediction block into the plurality of regions includes classifying classes to which the pixels included in the prediction block belong according to the properties of the pixels, and setting pixels that belong to the same class or similar classes as a region of the plurality of regions according to a result of classifying the classes.

In some embodiments, the motion compensation method further includes calculating an offset prediction block by adding values of the pixels included in the plurality of regions to the offset values corresponding to the plurality of regions.

In some embodiments, the prediction block includes a first pixel included in a first region and a second pixel included in a second region, and the calculating the offset prediction block comprises adding a first offset value to the first pixel and adding a second offset value to the second pixel.

In some embodiments, the prediction block comprises first through nth regions (here, n is an integer equal to or greater than 2), and the calculating of the plurality of offset values comprises calculating first through nth offset values corresponding to the first through nth regions, respectively.

### BRIEF DESCRIPTION OF THE DRAWINGS

The foregoing and other features and advantages of the inventive concepts will be apparent from the more particular description of embodiments of the inventive concepts, as illustrated in the accompanying drawings in which like reference characters refer to the same parts throughout the different views. The drawings are not necessarily to scale, emphasis instead being placed upon illustrating the principles of the inventive concepts.

FIG. 1 is a block diagram of a video encoding apparatus according to an example embodiment of the present inventive concepts.

FIG. 2 is a block diagram of a video decoding apparatus according to an example embodiment of the present inventive concepts.

FIG. 3 is a block diagram of an encoder illustrated in FIG. 1 according to an example embodiment of the present inventive concepts.

FIG. 4 is a block diagram of an encoder according to an example embodiment of the present inventive concepts.

FIG. 5 is a block diagram of a motion compensation unit illustrated in FIG. 4 according to an example embodiment of the present inventive concepts.

FIGS. 6A and 6B are block diagrams illustrating operations of calculating offset values according to characteristics of pixels in a prediction block according to an example embodiment of the present inventive concepts.

FIG. 7 is a diagram illustrating an example of integer pixels and sub-pixels configuring a prediction block according to an example embodiment of the present inventive concepts.

FIG. 8 is a diagram illustrating an example of calculating an offset value according to an example embodiment of the present inventive concepts.

FIGS. 9A and 9B are diagrams illustrating various examples of setting regions in a prediction block according to properties of pixels according to an example embodiment of the present inventive concepts.

FIG. 10 is a diagram illustrating an example of an edge class of an edge type, according to an example embodiment of the present inventive concepts.

FIGS. 11A and 11B are diagrams illustrating categories of the edge type illustrated in FIG. 10 according to an example embodiment of the present inventive concepts.

FIGS. 12 and 13 are flowcharts of a video encoding method according to an example embodiment of the present inventive concepts.

FIG. 14 is a block diagram of a decoding unit included in a decoding apparatus according to an example embodiment of the present inventive concepts.

FIG. 15 is a block diagram of a motion compensation unit illustrated in FIG. 14 according to an example embodiment of the present inventive concepts.

FIG. 16 is a flowchart of a video decoding method according to an example embodiment of the present inventive concepts.

FIG. 17 is a block diagram of an application processor including an encoding apparatus and/or a decoding apparatus according to an example embodiment of the present inventive concepts.

FIG. 18 is a diagram illustrating a configuration of a content supply system for providing a content distribution service, according to an example embodiment of the present inventive concepts.

FIG. 19 is a diagram illustrating an example of a mobile terminal including a video encoding apparatus according to an example embodiment of the present inventive concepts.

### DETAILED DESCRIPTION OF THE EMBODIMENTS

Various example embodiments will be described more fully hereinafter with reference to the accompanying drawings, in which example embodiments of the present inventive concepts are shown. The present inventive concepts may, however, be embodied in many different forms and should not be construed as limited to the example embodiments set forth herein.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concepts.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concepts. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concepts.

The present inventive concepts relate to motion estimation and motion compensation. When processing a prediction block used in the motion estimation and compensation operations, properties, for example, brightness, edge characteristics, or the like, of each pixel in the prediction block are detected. The prediction block is divided into two or more regions according to a detection result, and different offset values are applied to different regions so that the pixel values in the original block and the pixel values in the prediction block become similar to each other. Thus, compression efficiency is improved.

For example, when pixels in the original image are all white, whereas some pixels in the prediction block are white and the other pixels are black, the brightness of the prediction block is detected and the prediction block is divided into two regions. Accordingly, different offset values may be set with respect to black pixels and white pixels in the prediction block.

Since the prediction block (improving brightness of the black pixels) is compensated by using the offset values, differences between the pixels values in the original block and the prediction block may be reduced.

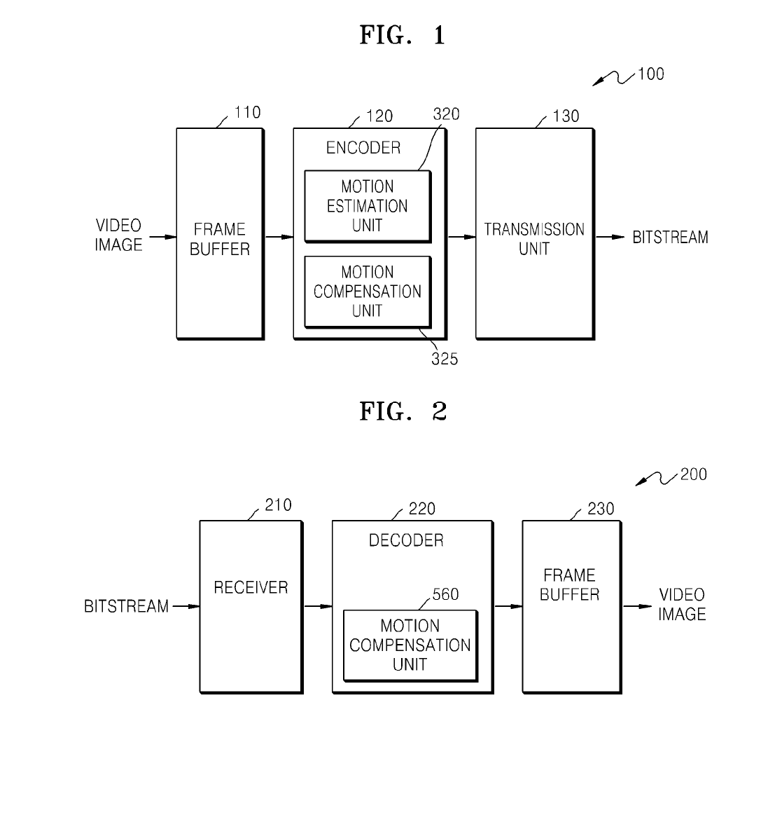

FIG. 1 is a block diagram of a video encoding apparatus 100 according to an example embodiment of the present inventive concepts. As illustrated in FIG. 1, the video encoding apparatus 100 may include a frame buffer 110, an encoder 120, and a transmission unit 130. The encoder 120 may further include a motion estimation unit 320 and a motion compensation unit 325.

The frame buffer 110 receives a video image VIDEO IMAGE. Information about the video image may be temporarily stored in the frame buffer 110, for example, a video image of a frame unit may be temporarily stored in the frame buffer 110. The video image temporarily stored in the frame buffer 110 is provided to the encoder 120 to be encoded. The encoder 120 may perform motion estimation and compensation to perform an encoding operation via an inter prediction method, for example. Alternatively, the encoder 120 may generate encoded image data through intra prediction, frequency transformation, and quantization. The transmission unit 130 may transfer the encoded image data from the encoder 12 to the outside as a bit stream BITSTREAM.

Motion estimation technology is widely applied to video compression standards such as motion picture experts group (MPEG) or H.26x. The motion estimation technology may perform operations of calculating a motion vector (MV) which represents a location variation between a current image and a previous image due to motion of an object in a moving picture, movement of a camera, and expansion and reduction of the image.

In order to calculate the MV, it is determined whether motion estimation is performed in a pixel unit or a block unit. For example, during a moving picture compression process, the motion estimation may generally be performed in the block unit. A block matching algorithm is a technique of estimating a MV between a current frame and a previous frame in a block unit, and the block used in the block matching algorithm may be defined as a macroblock. According to the block matching algorithm, a block of a current frame and a block of a previous frame are compared with each other in a predetermined search area of the previous frame, and, then, an operation of searching for a location of the most similar block may be performed. Through the above motion estimation operation, a prediction block corresponding to the block of the current frame may be identified.

In addition, the motion compensation unit may perform a motion compensation operation for generating data (for example, prediction data) of a prediction block based on the MV. Such motion estimation and compensation operations may be performed at an accuracy of a fractional pixel or a sub-pixel unit (hereinafter, referred to as a sub-pixel), other than an integer pixel unit, in order to reduce a prediction error. For example, in performing a motion estimation operation of a sub-pixel unit, the motion estimation unit may generate a MV for identifying a prediction block about other locations than an integer pixel location. Although not shown in FIG. 1, in order to perform the motion estimation and compensation operations in the sub-pixel unit, the encoder 120 may further include one or more interpolation filtering units for calculating sub-pixel values by performing interpolation on the integer pixels.

In addition, the encoder 120 may further include units for generating a reconstructed image of a previous frame in order to perform inter-prediction. For example, the encoder 120 may generate decoded image data through inverse-quantization, frequency inverse-transformation, inter-prediction/motion compensation, and intra prediction on encoded image data. That is, the operations of generating the reconstructed image in the encoder 120 may be performed through inverse processes of the video encoding method.

In addition, the encoder 120 according to the example embodiment of FIG. 1 may calculate and assign an offset value of the prediction block when performing the motion estimation and compensation operations. The offset value of the prediction block is calculated and assigned in order to improve compression efficiency by reducing a difference between data of the prediction block and a block of the current frame that is to be encoded (hereinafter, referred to as a current block). As an example, the prediction block may be classified as two or more regions according to properties of the pixels included in the prediction block, and different offset values are assigned to the two or more regions. For example, a class of each of the pixels in the prediction block is detected according to properties of the pixels, and accordingly, the corresponding prediction block is divided into at least two regions, each of which may have a different offset value. When generating prediction data related to the prediction block, each of the pixels in the prediction block is added to an offset value assigned to a region in which the corresponding pixel is included. Data obtained by the adding operation, for example, offset prediction data, may be generated as a motion compensation result. Processes of calculating the offset prediction data may be described as processes of applying an offset compensation to the prediction block corresponding to the MV.

FIG. 2 is a block diagram of a video decoding apparatus 200 according to an example embodiment of the present inventive concepts. As shown in FIG. 2, the video decoding apparatus 200 may include a receiver 210, a decoder 220, and a frame buffer 230. The receiver 210 receives a bitstream, for example BITSTREAM, provided from the video encoding apparatus, for example, video encoding apparatus 100, and may provide the bitstream to the decoder 220. Also, an image recovered by the decoder 220 is temporarily stored in the frame buffer 230, and image information may be output from the frame buffer 230 as a video image VIDEO IMAGE to display a corresponding image.

The decoder 220 receives and parses the bitstream BITSTREAM having the encoded image so as to extract information about the encoded image data and an offset value from the bitstream BITSTREAM. The information about the offset value may be generated and encoded by a video encoding apparatus, for example video encoding apparatus 100, as described above in connection with FIG. 1, two or more offset values calculated with respect to the prediction block may be included in the bitstream. Also, the prediction block may be divided into two or more regions according to properties of pixels included therein, and offset values that are different according to the regions may be included in the bitstream BITSTREAM.

In addition, the decoder 220 may extract encoding information that is necessary for decoding the encoded image data, such as an encoding type and an encoding mode. According to the example embodiment of FIG. 2, the decoder 220 may extract information about a filter coefficient from the bitstream BITSREAM when the information about the filter coefficient for an adaptive loop filtering is inserted in the bitstream BITSTREAM. The decoder 220 may decode the encoded image data from the video encoding apparatus 100 by using the encoded image data, the encoding information, and the information about the loop filter coefficient. The decoder 220 may perform the loop filtering operation to generate a reconstruction image. The decoding operation of the encoded image data may be performed through inverse processes of the video encoding method of the encoded image data.

The decoder 220 may include a motion compensation unit 560 for reconstructing the encoded video data by performing inter-prediction and motion compensation. The motion compensation unit 560 may reconstruct an original image by using an MV included in the bitstream BITSTREAM, residue data corresponding to a differential value between the current block and the prediction block, and offset values according to the example embodiment of the present inventive concepts. For example, the prediction block is selected via the MV, and prediction data corresponding to the prediction block may be generated by calculating the prediction block and the residue data. Also, the offset values calculated with respect to the two or more regions in the prediction block are added to the prediction data by the region unit to reconstruct the original image. The reconstruction image may be used in the video decoding apparatus 200 via the frame buffer 230.

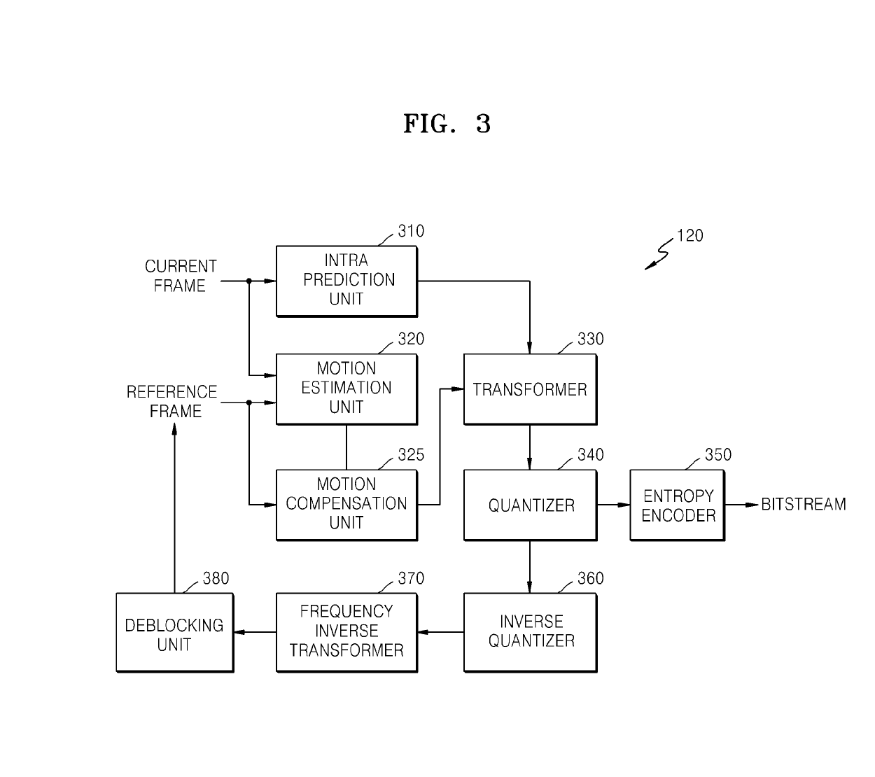

FIG. 3 is a block diagram of the encoder 120 illustrated in FIG. 1 according to an example embodiment of the present inventive concepts. As illustrated in FIG. 3, the encoder 120 may include various functional blocks for encoding the current frame. The current frame is an encoding and decoding unit including a plurality of blocks.

The encoder 120 may include an intra prediction unit 310, the motion estimation unit 320, and the motion compensation unit 325. The intra prediction unit 310 and the motion estimation unit 320 receive the current frame CURRENT FRAME. The motion estimation unit 320 and the motion compensation unit 325 receive a reference frame REFERENCE FRAME. The intra prediction unit 310 performs intra prediction on a coding unit of an intra mode in the current frame CURRENT MODE. Also, the motion estimation unit 320 and the motion compensation unit 325 perform motion estimation and motion compensation processes by using the current frame of an inter mode and the reference frame REFERENCE FRAME.

Data output from the intra prediction unit 310, the motion estimation unit 320, and the motion compensation unit 325 may be output as a quantized transformation coefficient via a transformer 330 and a quantizer 340. The quantized transformation coefficient is restored as data in a spatial domain through an inverse quantizer 360 and a frequency inverse transformer 370. The restored data in the spatial domain is post-processed through a deblocking unit 380 and output as the reference frame from the deblocking unit 380. The quantized transformation coefficient from the quantizer 340 may be output as a bitstream BITSREAM through an entropy encoder 350.

The motion estimation unit 320 and/or the motion compensation unit 325 may calculate an offset value of each region in the prediction block according to the embodiment embodiments. Accordingly, the motion estimation unit 320 and/or the motion compensation unit 325 minimize a pixel value difference between the original image and the prediction block, to which the offset value is applied, in order to improve compression efficiency. Also, in order to improve an accuracy of the inter-prediction, a prediction block of a sub-pixel location may be generated in addition to the prediction block of an integer pixel location. To do this, the encoder 120 may further include one or more filters (not shown) performing an interpolation filtering operation. Alternatively, the motion estimation unit 320 or the motion compensation unit 325 may include the one or more filters (not shown) to perform an interpolation operation.

In addition, as described above, the prediction block may be classified as two or more regions according to properties of the pixels (for example, brightness, edges, or the like). The offset value may vary according to the region. That is, the two or more regions may have different offset values. The bitstream BITSTREAM output from the encoder 120 may include information about a MV, information representing whether the offset value of the region unit in the prediction unit may be applied, information about a type of property (for example, the brightness, the edge, or the like) used to classify the regions of the prediction block, and the offset values calculated from each of the regions. The bitstream BITSTREAM output from the encoder 120 may include information representing whether the offset values with respect to the regions will be applied or not, and the classifying of the prediction block into the plurality of regions may be selectively performed according to a status of the information.

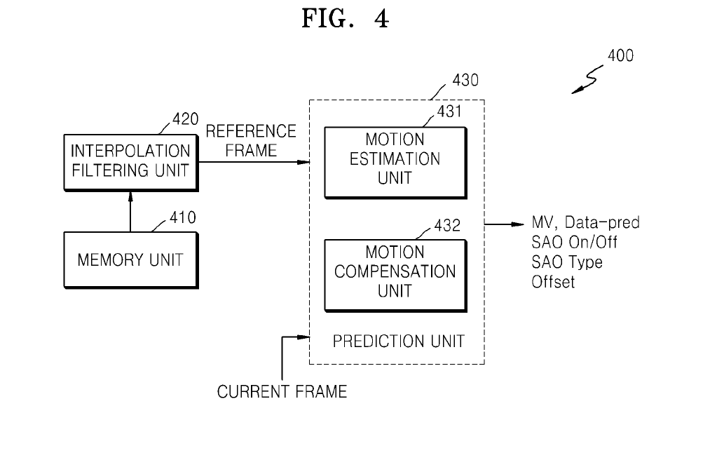

An encoder 400 illustrating the inter-prediction operation in more detail is shown in FIG. 4. FIG. 4 is a block diagram of the encoder 400 according to an example embodiment of the present inventive concepts.

As shown in FIG. 4, the encoder 400 may include a memory 410, an interpolation filtering unit 420, and a prediction unit 430. The prediction unit 430 may be defined as a unit performing an inter-prediction operation through the motion estimation and compensation operations. Accordingly, the prediction unit 430 may include a motion estimation unit 431 and a motion compensation unit 432. The prediction unit 430 receives a a reference frame REFERENCE FRAME from the interpolation filtering unit 420 and a current frame CURRENT FRAME.

The memory 410 may temporarily store a reference frame that is used in the inter-prediction and provide the reference frame to the interpolation filtering unit 420. Also, the interpolation filtering unit 420 may perform an interpolation filtering operation by performing interpolation calculations on a plurality of pixel values in the reference frame. Accordingly, the interpolation filtering unit 420 may provide a prediction block including integer pixels (for example, an integer prediction block) or a prediction block including sub-pixels corresponding to the sub-pixels (for example, ½, ¼, ⅛ pixels, or the like) (for example, a sub-prediction block) to the prediction unit 430. The prediction unit 430 may generate a MV representing relative locations between the block of the current frame that will be encoded through the motion estimation operation and the prediction block (for example, the integer prediction block or the sub-prediction block).

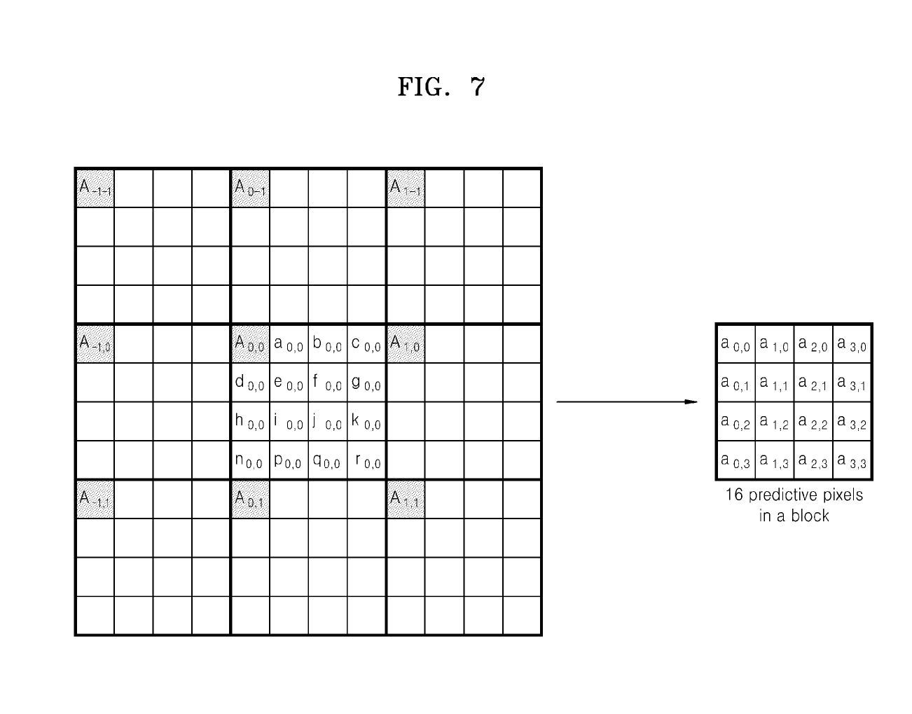

The prediction block including the integer pixels or the sub-pixels will be described below in connection with FIG. 7.

FIG. 7 is a diagram illustrating an example of integer pixels and sub-pixels constituting the prediction block. A reference frame may include a plurality of integer pixels. When generating a prediction block from the reference frame, the prediction frame may include integer pixels or sub-pixels located between the integer pixels. At a left side of FIG. 7, pixels denoted by capital A (A_{-1,1}-A_{1,1}) are integer pixels, and pixels denoted by small a (a_{0,0}-a_{3,3}) are sub-pixels that may be generated by interpolating the integer pixels.

The sub-pixels, for example, a_{0,0}-a_{3,3}, may be generated from the integer pixels through a calculation expressed by Equation 1 below. If the encoding through the inter-prediction is performed in a block unit including 4×4 pixels, a sub-prediction block including 4×4 sub-pixels may be generated by Equation 1. A value (prdᵢ) of each sub-pixel may correspond to a sum of values obtained by multiplying values (prdⱼ) of the plurality of integer pixels by weight values (wⱼ) applied respectively to the integer pixels. For example, in order to calculate a value of one sub-pixel (for example, a_{0,0}), the values of the plurality of integer pixels adjacent to the sub-pixel (a_{0,0}) may be used, and different weight values may be applied to the plurality of integer pixels. Equation 2 below is provided to calculate the sub-pixel by applying the weight values to the integer pixels.

$$\begin{matrix}{prd}_{i} = {\sum }_{j ∈ fs} {w}_{j} \times {prd}_{j} & ( 1 ) \\ {a}_{0 , 0} = ( - {A}_{- 3 , 0} + 4 {A}_{- 2 , 0} - 10 {A}_{- 1 , 0} + 58 {A}_{0 , 0} + 17 {A}_{1 , 0} - 5 {A}_{2 , 0} + {A}_{3 , 0} ) / 64 & ( 2 )\end{matrix}$$

Referring back to FIG. 4, the motion estimation unit 431 generates a MV representing an integer prediction block or a sub-prediction block in the reference frame REFERENCE FRAME, which corresponds to a block of the current frame CURRENT FRAME that is to be encoded. The motion compensation unit 432 generates prediction data Data_pred based on the MV. The prediction unit 430 may output the prediction data Data_pred. The prediction data Data_pred may correspond to values of the pixels in the prediction block, which minimize the difference between the pixels between the original block and the prediction block. As described above, since the motion estimation may be performed from the sub-prediction block, as well as the integer prediction block, the MV representing the prediction block that is more similar to the original block may be obtained, and prediction data Data_pred corresponding to the MV may be generated.

In addition, an operation of classifying classes of the pixels is performed in consideration of the properties of the pixels in the prediction block, and the prediction block may be classified as two or more regions based on the classifying operation. In addition, each of the two or more regions may have an offset value. The offset values of the two or more regions may be different from each other, for example, a sample adaptive offset. As described in the previous example embodiment, the offset values may be encoded and output from the prediction unit 430, and information representing whether an adaptive offset will be applied (SAO on/off) may be encoded with information about the classifying operation (SAO type, for example, information about properties of the pixels, which are criteria of the classifying operation) and output from the prediction unit 430. Information representing whether the offset values with respect to the regions will be applied or not may be output from the predication unit 430, and the classifying of the prediction block into the plurality of regions may be selectively performed according to a status of the information.

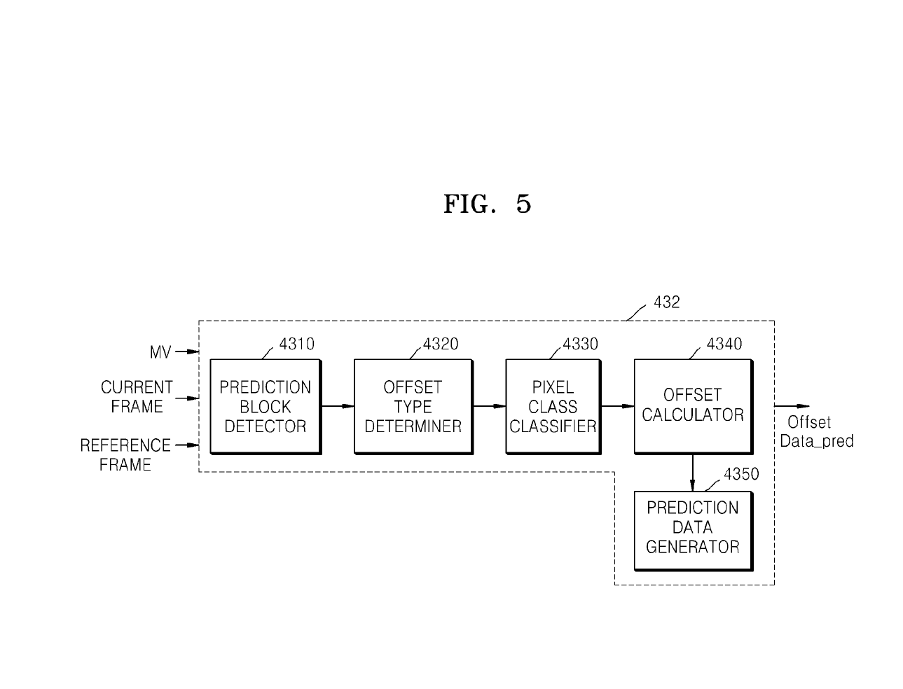

FIG. 5 is a block diagram of the motion compensation unit 432 of FIG. 4 according to an example embodiment of the present inventive concepts. Examples of calculating the offset and generating prediction data according to the offset will be described below with reference to FIG. 5.

As illustrated in FIG. 5, the motion compensation unit 432 may include a prediction block detector 4310, an offset type determiner 4320, a pixel class classifier 4330, an offset calculator 4340, and a prediction data generator 4350. The motion compensation unit 432 receives the MV, the current frame CURRENT FRAME and the reference frame REFERENCE FRAME. The motion compensation unit 432 outputs offset value Offset and prediction data Data_pred.

The prediction block detector 4310 detects the prediction block from the reference frame based on the MV calculated through the motion estimation operation of the motion estimation unit 430. The detected prediction block (or pixel values of the prediction block) may be provided to the pixel class classifier 4330 via the offset type determiner 4320. The offset type determiner 4320 may provide a criterion for classifying properties of the pixels according to predetermined information. Alternatively, the offset type determiner 4320 may determine a criterion for classifying the properties of the pixels in the corresponding block from the pixel values of the prediction block, and may provide information about the criterion.

The pixel class classifier 4330 may classify the prediction block into a plurality of regions. The region classifying operation performed by the pixel class classifier 4330 may be described as an operation of classifying classes of the pixels. For example, a brightness value or an edge characteristic of each pixel may be determined with reference to the pixel value, and each of the pixels may be classified as one of the plurality of classes according to the result of the determination. The pixels in the same class may constitute a region, or in the example embodiments of the present inventive concepts, the pixels classified to be in similar classes may be set as one region.

The offset calculator 4340 calculates offset values according to the result of the pixel classes determined by the pixel classifier 4330. For example, if the prediction block includes three regions, first through third offset values may be calculated with respect to the regions. That is, for example, a relatively high offset value may be calculated from the pixels in the prediction block having relatively low brightness, and, for example, a relatively low offset value may be calculated from the pixels having relatively high brightness in the prediction block. Through the offset calculation operation, the prediction data generator 4350 may generate and output prediction data Data_pred related to the pixel values within the detected prediction block. When the prediction data generator 4350 generates the prediction data Data_pred, prediction data that is offset-compensated (for example, offset prediction data Data_pred) may be generated by adding each pixel value to the offset value set in correspondence with each of the pixels.

A differential value between the offset prediction data Data_pred, to which the offset value is applied, and the data value of the original block is calculated through a data encoding process, and an encoding result according to the differential value is included in the bitstream BITSTREAM that is provided to a video decoding apparatus, for example video decoding apparatus 200. According to the example embodiments, two or more offset values are calculated from the prediction block according to the properties of the pixels, and the encoding operation is performed according to the difference between the prediction data that is offset compensated Data_pred and the pixel value of the original block. Accordingly, compression efficiency is improved.

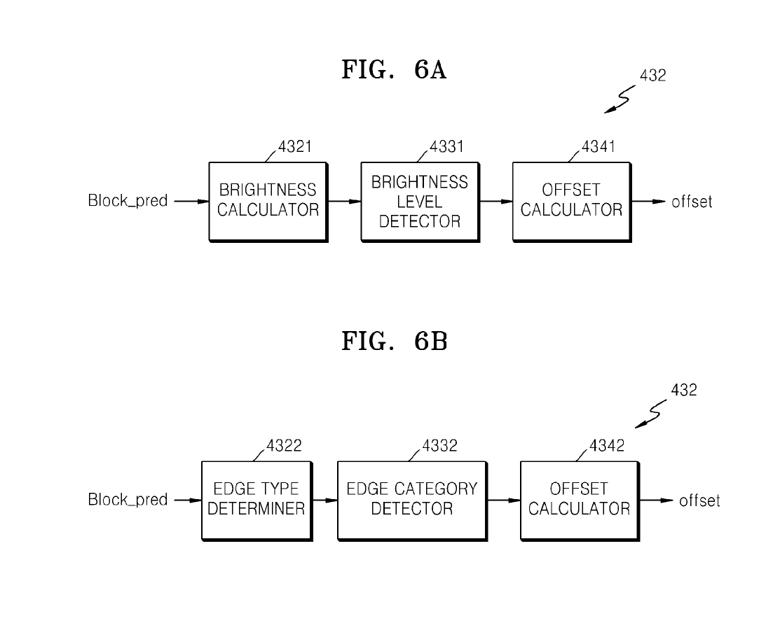

FIGS. 6A and 6B are block diagrams illustrating examples of calculating offset values according to properties of pixels in the prediction block according to an example embodiment of the present inventive concepts. In FIG. 6A, the prediction block is classified as a plurality of regions according to the brightness of the pixels, and in FIG. 6B, the prediction block is classified as a plurality of regions according to edge characteristics of the prediction block.

As shown in FIG. 6A, the motion compensation unit 432 may include a brightness calculator 4321 as a unit for determining an offset type and a brightness level detector 4331 as a unit for classifying pixel classes. The motion compensation unit 432 may further include an offset calculator 4341 for calculating two or more offset values of the prediction block according to the detected brightness level.

The brightness calculator 4321 may receive the prediction block Block_pred and output information representing whether the operation of classifying the regions according to the brightness characteristics of the pixels in the corresponding prediction block Block_pred with reference to a result of calculating the brightness of the pixels included in the prediction block Block_pred. In addition, the brightness level detector 4331 may detect the brightness of a pixel through a pixel value of the pixel. For example, the brightness level detector 4331 may detect a level of a brightness of the corresponding pixel from among a plurality of level ranges and output information about the brightness level. According to the brightness level, each of the pixels may be classified as one of the plurality of classes. The offset calculator 4341 may calculate an offset value of each of the pixels according to the class to which each pixel belongs. Accordingly, at least two different offset values may be calculated with respect to the plurality of regions included in one prediction block.

As shown in FIG. 6B, the motion compensation unit 432 may include an edge type determiner 4322 as a unit for determining the offset type and an edge category detector 4332 as a unit for classifying pixel classes. Also, the motion compensation unit 432 may further include an offset calculator 4342 for calculating two or more offset values with respect to the prediction block, according to the detected edge categories.

The edge type determiner 4322 may receive the prediction block Block_pred and output information representing whether an operation of classifying the regions according to the edge type in the corresponding prediction block Block_pred through an edge detection calculation with respect to the pixels included in the prediction block Block_pred. In addition, the edge category detector 4332 may detect a category to which each of the pixels belongs in relation to the detected edge type. According to the edge category, each of the pixels may be classified as one of the plurality of classes. The offset calculator 4342 may calculate an offset value of each pixel according to the class to which each pixel belongs, and accordingly, at least two different offset values of the plurality of regions included in one prediction block may be calculated.

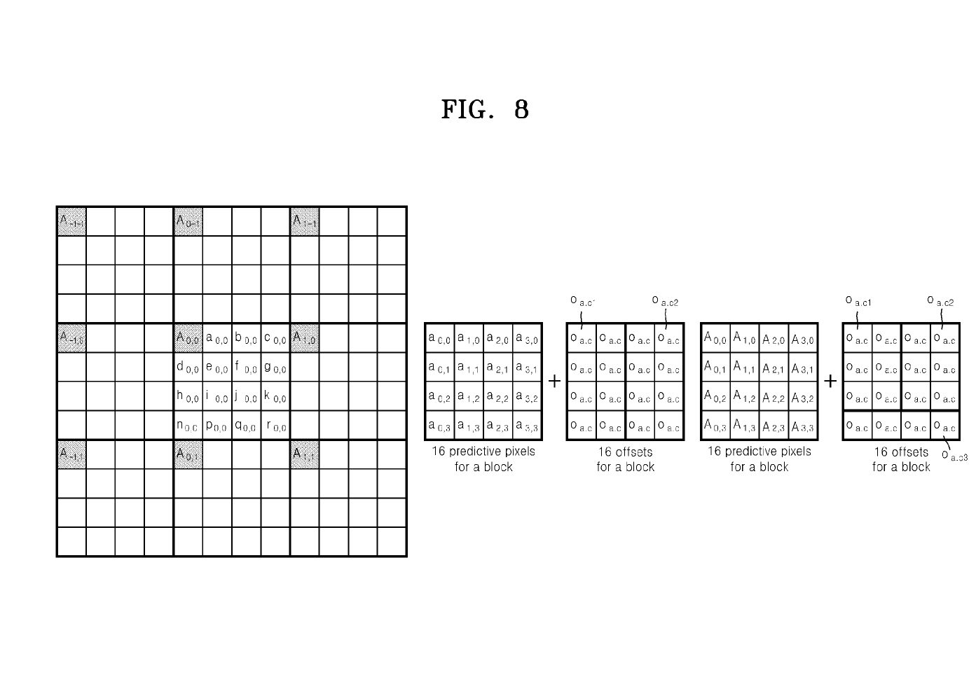

FIG. 8 is a diagram illustrating an example of a calculation of the offset value in accordance with an example embodiment of the present inventive concepts. FIG. 8 illustrates examples of offset values that are defined with respect to an integer prediction block and a sub-prediction block, with the example of generating the prediction block.

Similar to FIG. 7, a reference frame for performing inter-prediction includes a plurality of blocks, each of which may include a plurality of integer pixels. As illustrated in FIG. 8, pixels expressed by capital A (A_{-1,1}-A_{1,1}) at a left side of a block of FIG. 8 denote integer pixels. Also, sub-pixels values may be calculated from the integer pixels through an interpolation filtering process, for example, pixels expressed by small letters (a_{0,0}-r_{0,0}) denote sub-pixels.

The sub-prediction blocks may be generated through the interpolation of the plurality of integer pixels. As described in the above example embodiment of FIG. 7, the pixel values of a plurality of integer pixels adjacent to a sub-pixel may be calculated to obtain the pixel value of the sub-pixel. Also, the sub-prediction block includes the sub-pixels corresponding to other locations than the locations of the integer pixels. FIG. 8 illustrates one sub-prediction block including a plurality of sub-pixels a_{0,0}-a_{3,3}. If 4×4 pixels are defined as a motion estimation unit, one sub-prediction block may include 16 sub-pixels.

When the prediction block is generated as above, the prediction block may be classified into a plurality of regions according to properties of the pixels. Although not shown in FIG. 8, various properties of the pixels may be applied to classify the regions, for example, the regions may be classified by the brightness values or edge characteristics of the pixels. Prediction data to which the offset is applied (for example, offset prediction data) may be calculated by Equation 3 below.

$${prd}_{i} = {\sum }_{j ∈ fs} {w}_{j} \times {prd}_{j} + {o}_{i , c} \\ where \\ {o}_{i , c} = \frac{{\sum }_{i , c} {( {org}_{i , c} - {prd}_{i , c} )}^{2}}{N} \qquad ( 3 )$$

Referring to Equation 3 above, a value (prdᵢ) of a sub-pixel may correspond to a value obtained by performing multiplying operations of the values (prdⱼ) of the plurality of integer pixels after applying predetermined weight values (wⱼ) thereto, and adding the multiplication results. Also, as described above, when it is assumed that one prediction block is classified as a plurality of regions, offset values (o_{i,c}) that are different from each other may be defined with respect to the plurality of regions. The prediction data related to the prediction block may be generated by adding the pixel values of the prediction block to the offset values calculated with respect to the regions to which the pixels belong.

When calculating the offset values for each of the regions, a subtracting calculation between pixel values in an original block (org_{i,c}) and pixel values in a prediction block in a certain region (prd_{i,c}) is performed, subtraction results are squared, and squared values are added to each other. The result of adding the squared results may be divided by the number of pixels N included in the certain region to calculate an average value, and the average value may be defined as an offset value of the corresponding region. The above calculation for obtaining the offset value is an example embodiment of the present inventive concepts, that is, the offset value of each region may be calculated by using other equations.

Referring to FIG. 8, a sub-prediction block including 4×4 sub-pixels may be generated by calculating the values of the plurality of integer pixels, and it may be assumed that the sub-prediction block may be classified as two regions according to properties of the pixels included therein. According to this, two offset values may be calculated with respect to the sub-prediction block. In FIG. 8, the values of the pixels in the left two rows (4×2 pixels) in the sub-prediction block are added to a first offset value (o_{i,c}1) to generate prediction data of each of the pixels, and the values of the pixels in the right two rows (4×2 pixels) in the sub-prediction block are added to a second offset value (o_{i,c}2) to generate prediction data of each of the pixels. Also, an integer prediction block including integer pixels is illustrated, and the integer prediction block is classified as three regions according to properties of the pixels included therein. In this case, three offset values (o_{i,c}1˜o_{i,c}3) may be set with respect to the integer prediction block, and the value of each of the pixels is added to the corresponding offset value to generate prediction data.

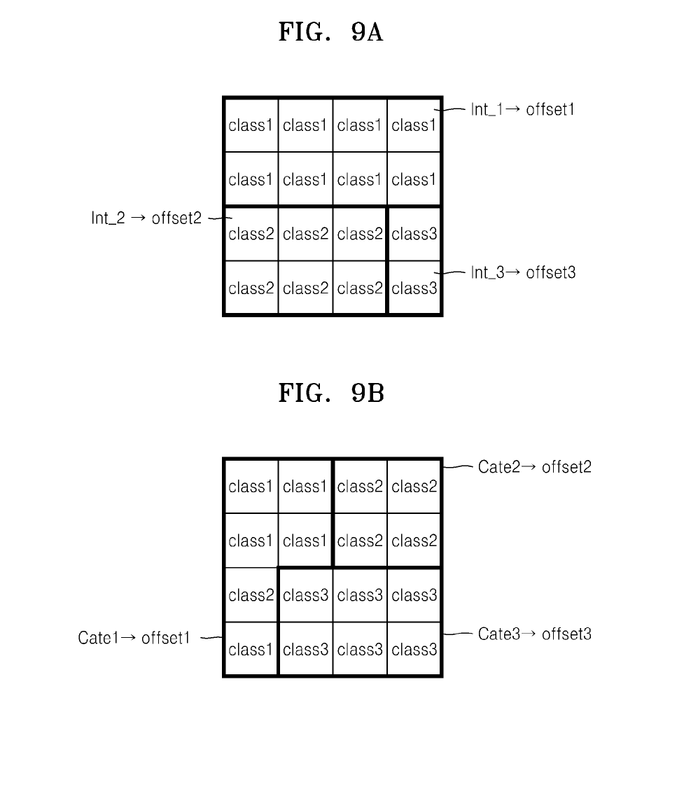

FIGS. 9A and 9B are diagrams illustrating various examples of setting regions in a prediction block according to properties of the pixels according to an example embodiment of the present inventive concepts.

As illustrated in FIGS. 9A and 9B, each of the pixels may be classified as one of a plurality of classes according to properties thereof. For example, as shown in FIG. 9A, pixels having a brightness in a first range Int 1 may be classified as a first class class1, and pixels having a brightness in a second range Int 2 may be classified as a second class class2. Similarly, pixels having a brightness in a third range Int 3 may be classified as a third class class3. As described above, when the regions are classified according to the properties of the pixels (for example, brightness property), offset values may be set with respect to each of the regions. For example, the first offset value offset1 is added to the pixels classified as the first class class1 to be provided as prediction data, and second and third offset values offset2 and offset3 are added respectively to the pixels classified as the second class class2 and third class class3 to be provided as prediction data.

FIG. 9B shows an example of classifying pixels as one of a plurality of classes according to edge characteristics of the pixels. For example, in FIG. 9B, an edge type of the prediction block may be detected, and categories of the pixels based on the edge type may be detected. For example, the pixels included in a first category Cate1 may be classified as a first class class1, the pixels included in a second category Cate2 may be classified as a second class class2, and the pixels included in a third category Cate3 may be classified as a third class class3. As described above, the pixels classified as the first class class1 are added to a first offset value offset1 to be provided as prediction data, and similarly, the pixels classified as the second class class2 and third class class3 may be added to second and third offset values offset2 and offset3, respectively, to be provided as prediction data.

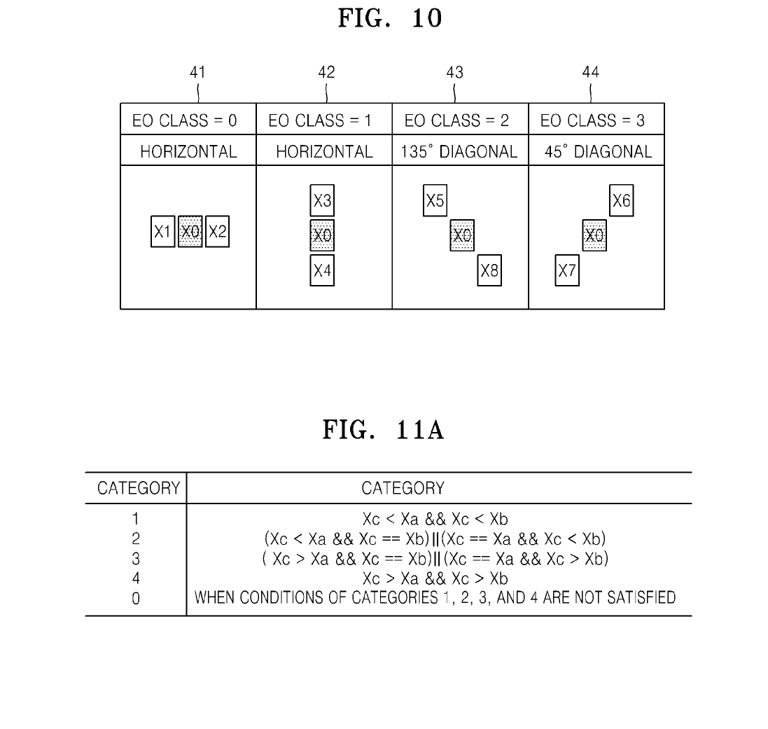

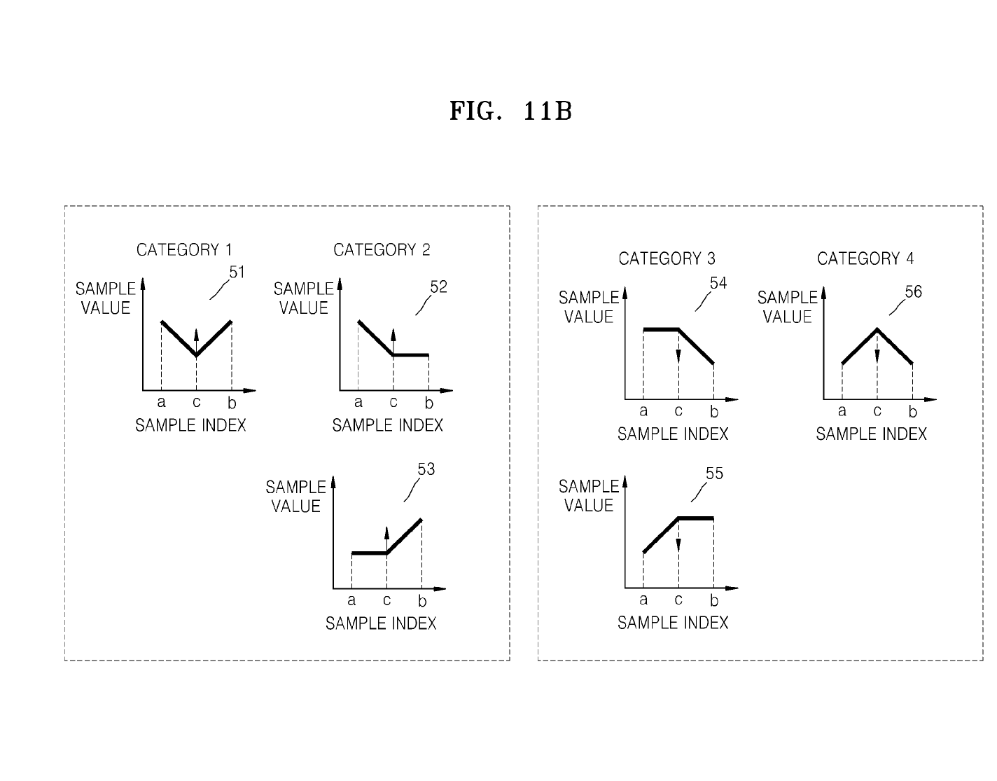

An example of classifying categories of pixels according to the edge characteristics will be described below in connection with FIGS. 10, 11A and 11B. FIG. 10 is a diagram illustrating an example of edge classes of the edge type in accordance with an example embodiment of the present inventive concepts, and FIGS. 11A and 11B are diagrams illustrating categories of the edge types in accordance with an example embodiment of the present inventive concepts.

Indexes 0, 1, 2, and 3 may be sequentially allocated to edge classes 41, 42, 43, and 44, respectively. When a generation frequency of the edge type is high, the index allocated to the edge type may be small. The edge class may denote a direction of a first-dimensional edge formed by one pixel X0 (for example, a current pixel) and two adjacent pixels. The edge class 41 having the index 0 denotes an embodiment in which the current pixel X0 and two neighboring pixels X1 and X2 adjacent to the pixel X0 in a horizontal direction form an edge. The edge class 42 having the index 1 denotes an embodiment in which the current pixel X0 and two neighboring pixels X3 and X4 adjacent to the pixel X0 in a vertical direction form an edge. The edge class 43 having the index 2 denotes an embodiment in which the current pixel X0 and two neighboring pixels X5 and X8 adjacent to the pixel X0 in a diagonal direction at an angle of 135° form an edge. The edge class 44 having the index 3 denotes an embodiment in which the current pixel X0 and two neighboring pixels X6 and X7 adjacent to the pixel X0 in a diagonal direction at an angle of 45° form an edge.

When detecting the edge characteristic, edge directions of the pixels included in a prediction block including integer pixels or a prediction block including sub-pixels obtained through interpolation filtering are analyzed to determine directions of the edges included in the prediction block, and accordingly, the edge category of each of the pixels included in the prediction block may be determined.

FIGS. 11A and 11B illustrate categories of the edge types according to the current example embodiment. The edge categories may denote, for example, whether the current pixel is a bottom of a concave edge, a pixel in a curved corner around the bottom of the concave edge, a peak of a convex edge, or a pixel in a curved corner around the peak of the convex edge.

FIG. 11A illustrates example conditions for determining the edge category. FIG. 11B shows graphs of the edge types of the current pixel and the neighboring pixels and the pixel values c, a, and b. Here, c denotes an index of the current pixel, and a and b denote indexes of the neighboring pixels adjacent to opposite sides of the current pixel according to the edge direction. In addition, Xa, Xb, and Xc denote pixel values of the pixels having indexes of a, b, and c. In FIG. 11B, x-direction axes in the graphs denote indexes of the current pixel, and the neighboring pixels adjacent to the opposite sides of the current pixel, and y-direction axes denote pixel values of the pixels.

Referring to FIG. 11A, Category 1 denotes an embodiment in which the current pixel c is a bottom of a concave edge, that is, a local valley point (Xc<Xa && Xc<Xb). As illustrated in graph 51 of FIG. 11B, in an embodiment in which the current pixel c is the local valley point between the neighboring pixels a and b, the current pixel c may be classified as Category 1. Category 2 denotes an embodiment in which the current pixel c is located at a concave corner around the local valley point (Xc<Xa && Xc==Xb∥Xc==Xa && Xc<Xb). Referring to FIGS. 11A and 11B, in an embodiment in which the current pixel c is located at a point where a descending curve of the concave edge terminates (Xc<Xa && Xc==Xb) between the neighboring pixels a and b, as illustrated in graph 52 of FIG. 11B, or in an embodiment in which the current pixel c is located at a point where a rising curve of the concave edge starts (Xc==Xa && Xc<Xb) between the neighboring pixels a and b, as illustrated in a graph 53 of FIG. 11B, the current pixel c may be classified as Category 2.

Referring to FIG. 11A, Category 3 denotes an embodiment in which the current pixel c is located at a convex corner around a peak of a convex edge (Xc>Xa && Xc==Xb∥Xc==Xa && Xc>Xb). Referring to FIGS. 11A and 11B, as illustrated in graph 54 of FIG. 11B, when the current pixel c is located at a point where curve of the concave edge descends between the neighboring pixels a and b (Xc==Xa && Xc>Xb), or, as illustrated in graph 55 of FIG. 11B, when the current pixel c is located at a point where a rising curve of the concave edge terminates (Xc>Xa && Xc==Xb), the current pixel c may be classified as Category 3. Category 4 denotes an embodiment in which the current pixel c is a peak of a convex edge, that is a local peak point (Xc>Xa && Xc>Xb). As illustrated in graph 56 of FIG. 11B, when the current pixel c is the local peak point between the neighboring pixels a and b, the current pixel c may be classified as Category 4. If the current pixel c does not satisfy the above conditions of Categories 1, 2, 3, and 4, the current pixel c has no edge, and may be classified as Category 0, as illustrated in FIG. 11A.

After determining the edge categories of the pixels included in the prediction block, the pixels having the same edge categories may be classified into the same regions. The prediction block may be classified as at least two regions based on the determined edge categories. Also, different offset values may be set according to the edge categories of the pixels, for example, a positive offset value or a negative offset value may be applied according to the edge type of the pixel. By setting the offset values to be different for each of the regions, a difference between the original block and the prediction block may be reduced.

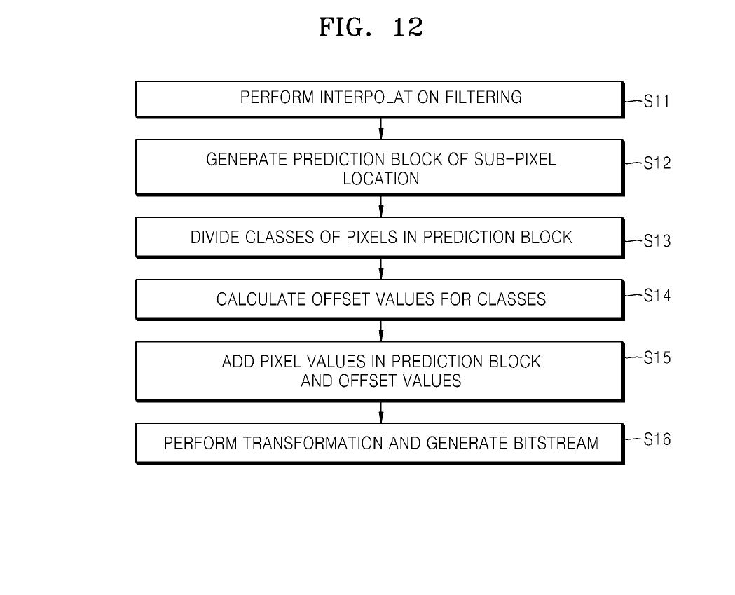

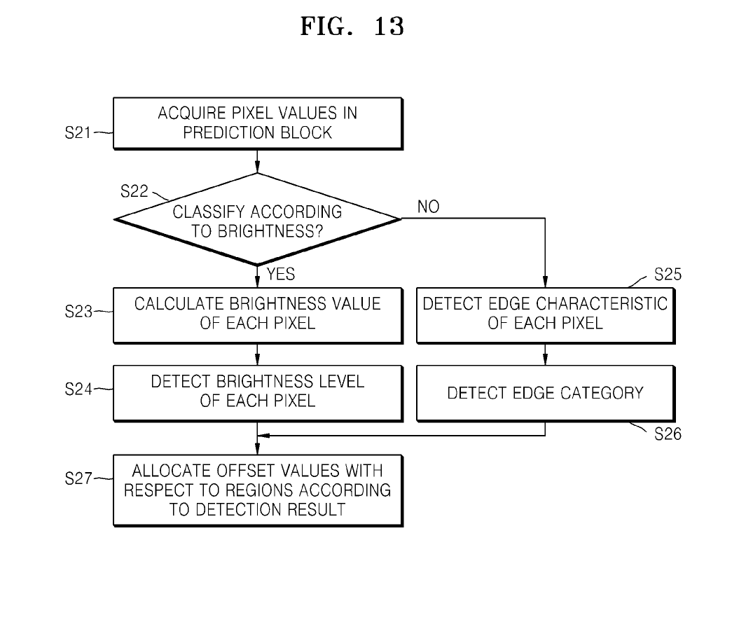

FIGS. 12 and 13 are flowcharts of a video encoding method according to an example embodiment of the present inventive concepts.

As shown in FIG. 12, when generating a prediction block from a reference frame, a block at an integer pixel location may be generated as a prediction block, or a block at a sub-pixel location may be generated as a prediction block in order to improve inter-prediction accuracy. In order to generate the block at the sub-pixel location, an interpolation filtering operation is performed (S11). In addition, a prediction block at the sub-pixel location is generated according to the interpolation filtering operation (S12), and pixels included in the prediction block are classified as a plurality of classes according to properties of the pixels (S13). Accordingly, the prediction block may be classified having at least two regions.

Each of the pixels is included in one of the plurality of classes, and an offset value of each of the pixels is calculated according to the class to which the pixel belongs (S14). Since the pixels included in the prediction block are included in one of the plurality of classes, two or more offset values may be calculated with respect to one prediction block.

Before performing a transformation operation for the video encoding, differential values between pixel values in a block of an original video and pixel values in the prediction block are calculated. Before calculating the differential values, offset prediction data is obtained by applying the offset values to the pixels in the prediction block. For example, the offset value set with respect to each of the pixels is added to each pixel value in the prediction block (S15), and data obtained by adding the offset value to the pixel value is provided as prediction data to perform the calculation of the differential values. According to the differential value calculation, the transformation operation is performed and a bitstream is generated (S16). The bitstream may include information including encoded motion vectors and offset values. In addition, the bitstream may include encoded information representing whether the offset is applied during a motion compensation operation and information about properties of the pixels detected from the prediction block.

In addition, as illustrated in FIG. 13, the offset values according to the properties of the pixels included in the prediction block may be applied to the video encoding method according to the embodiment of the present inventive concept.

Since the prediction block is generated through the MV generation and the interpolation filtering operation, the pixel values of the pixels (for example, integer pixels or sub-pixels) included in the prediction block may be acquired (S21). The pixel properties may be detected from the pixel values. It is determined which property of the pixels may be used to perform classification by, for example, preset information or properties of the reference frame. For example, it may be determined whether the classification operation is performed according to the brightness of the pixels in the prediction block (S22). In a case where the classification according to the brightness of the pixels is performed, a brightness value of each of the pixels is calculated (S23), and a brightness level of each pixel may be detected according to the calculation result (S24).

If it is determined that the classification operation will not be performed according to the brightness of the pixels, that is, if it is determined that the classification operation will be performed according to edge characteristics of the pixels in the prediction block, an edge characteristic (or edge direction) of each pixel may be detected by referring to the pixel values of a current pixel and neighboring pixels (S25). An edge category of each pixel may be detected according to the edge characteristic thereof (S26).

The prediction block is classified as at least two regions according to the brightness level detection or the edge category detection result or by another property of the pixel, and the offset value is applied to each of the at least two regions according to the detection result (S27). Accordingly, the prediction data may be generated by adding the pixel value in the prediction block and the offset value applied to the corresponding pixel.

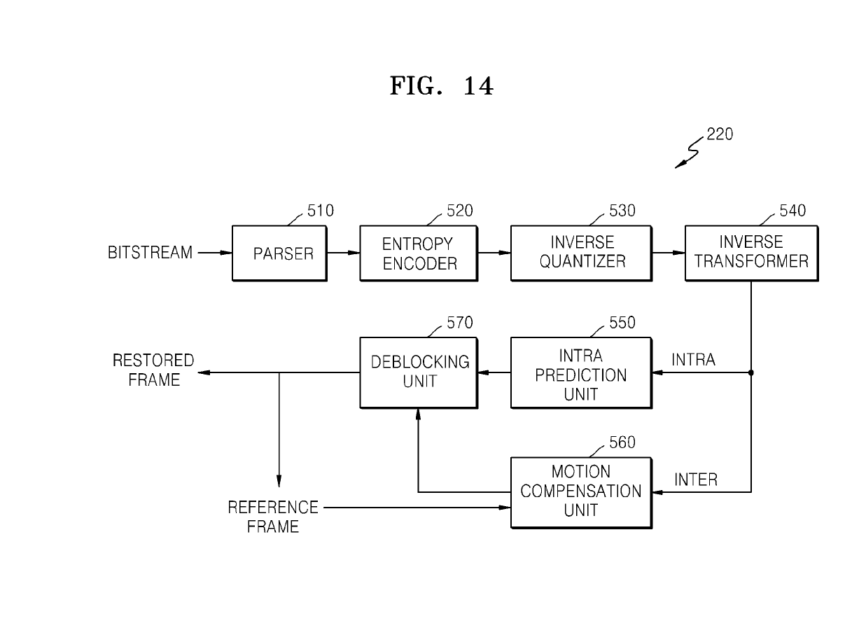

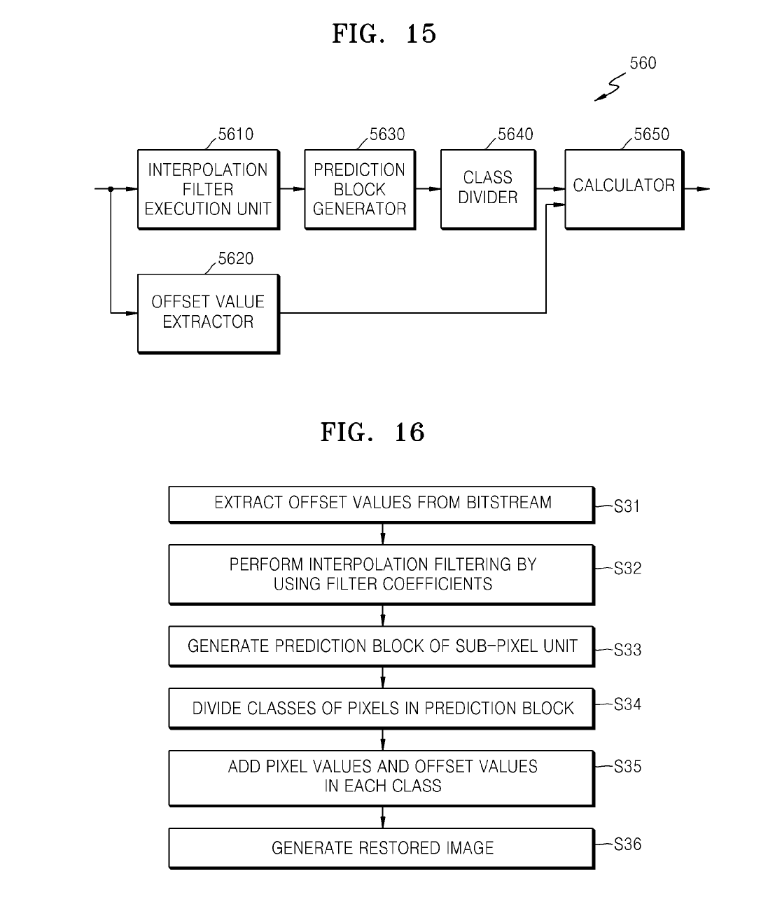

FIG. 14 is a block diagram of a decoder 220 included in a video decoding apparatus according to an embodiment of the present inventive concept. Configurations illustrated in FIG. 14 may be included in the decoder 220 of the video decoding apparatus of FIG. 2.

The decoder 220 may include a parser 510, an entropy decoder 520, an inverse quantizer 530, and an inverse transformer 540. For performing the motion compensation, the decoder 220 may further include an intra-prediction unit 550, a motion compensation unit 560, and a deblocking unit 570.

The bitstream BITSTREAM is provided to the parser 510. The parser 510 may parse encoded image data in the bitstream BITSTREAM that is to be decoded and information about the encoding operation that is necessary for performing the decoding operation. The encoded image data is output to the inverse transformer 540 as inversely quantized data through the entropy decoder 520 and the inverse quantizer 530. Image data of a spatial domain may be restored through the inverse transformer 540. With respect to the image data of the spatial domain, the intra-prediction unit 550 performs an intra-prediction on a coding unit of the intra-mode. The intra-predication unit 550 receives INTRA in the intra-mode. The motion compensation unit 560 may perform a motion compensation with respect to the coding unit of an inter-mode by using a reference frame 585. The motion compensation unit 560 receives INTER in an inter-mode. The image data of the spatial domain processed through the intra-prediction unit 550 and the motion compensation unit 560 may be post-processed by the deblocking unit 570 and output as a restored frame. Also, the data post-processed by the deblocking unit 570 may be output as a reference frame.

The motion compensation unit 560 may perform a motion compensation operation as described in the above embodiment. For example, the bitstream BITSTREAM may include encoded information about, for example, MV, offset values of the regions included in the prediction block, information representing whether the offset value is applied during the motion compensation, and pixel characteristic types. The above information may be parsed and restored to be provided to the motion compensation unit 560, and the motion compensation unit 560 classifies the prediction block as a plurality of regions based on the above information, and restores the original block by applying the offset values that are different for each of the regions to the prediction block. For example, the prediction block is generated from the reference frame with reference to the MV, the offset values are applied to the regions of the prediction block, and offset prediction data and residue data are calculated to restore the original block.

FIG. 15 is a block diagram of an example of the motion compensation unit 560 illustrated in FIG. 14 in accordance with an example embodiment of the present inventive concepts. As illustrated in FIG. 15, the motion compensation unit 560 includes an interpolation filtering execution unit 5610, an offset value extractor 5620, a prediction block generator 5630, a class divider 5640, and a calculator 5650. The motion compensation unit 560 may perform the motion compensation operation by applying the offset values with respect to the regions, according to the functional blocks illustrated in FIG. 15.

Various pieces of information about the motion compensation may be parsed from the bitstream, for example, the MV calculated when encoding image data, offset value information about regions in the prediction block, and pixel characteristic type information. In order to generate the prediction block by using the MV included in the bitstream, the interpolation filtering execution unit 5610 may perform an interpolation filtering operation. The interpolation filtering operation may be performed using a filter coefficient in order to calculate a prediction block of a sub-pixel unit The prediction block generator 5630 receives the output from the interpolation filtering unit 5610 and may generate the prediction block designated by the MV according to the interpolation filtering operation. The prediction block may include integer pixels or sub-pixels. In addition, when performing the interpolation filtering, the filter coefficient value applied to each of the integer pixels may be a fixed value or an adaptively varying value.

In addition, information about the property type of the pixels in the prediction block may be determined by using the information included in the bitstream. The class divider 5640 receives the output from the predication block generator 5630 and determines the properties of the pixels, that is, the criteria of classifying the regions, and may divide classes of the pixels included in the prediction block based on the properties. As described above, if the regions of the prediction block are classified by the brightness properties of the pixels, the class divider 5640 calculates a brightness value of each pixel in the prediction block, and may divide the class of each pixel according to a brightness level to which the pixel belongs from among a plurality of brightness levels. As described above, if the regions of the prediction block are classified by the edge characteristics of the pixels, the class divider 5640 determine an edge characteristic (or edge direction) of each pixel, an edge category of each pixel may be detected according to the edge characteristic thereof, and may divide the class of each pixel according to an edge category to which the pixel belongs from among a plurality of edge categories. In addition, the offset value extractor 5620 may extract offset values by using the parsed data from the bitstream BITSTREAM, for example, the offset value extractor 5620 may extract two or more offset values provided in one prediction block. The extracted offset values and the information about the class of each pixel may be provided to the calculator 5650. The calculator 5650 receives the pixel values of the prediction block, and may generate a prediction data block by using the information about the class to which each of the pixels belongs and the offset value applied to each of the classes. For example, the pixel value of each pixel in the prediction block is added to the offset value of the pixel to generate the prediction data block. The prediction data block generated as above may be added to differential value information (not shown) included in the bitstream, and the original image may be restored therefrom.

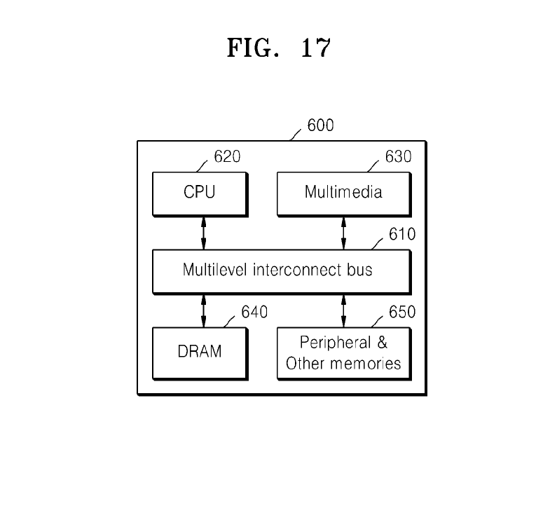

FIG. 16 is a flowchart of a video decoding method according to an example embodiment of the present inventive concepts.

As illustrated in FIG. 16, when a bitstream is transmitted from the encoding apparatus, various pieces of information included in the bitstream may be extracted, for example, the offset values for the regions in the prediction block may be extracted (S31). Also, an interpolation filtering operation may be performed in order to obtain the prediction block from the reference frame, for example, an interpolation filtering operation using a filter coefficient may be performed in order to calculate a prediction block of a sub-pixel unit (S32). The filter coefficient value may be a fixed value or an adaptively varying value. The prediction block of a sub-pixel unit may be generated according to the interpolation filtering operation (S33). Property information of the pixels is detected in order to classify the regions of the prediction block with reference to the information included in the bitstream. According to the detected information, an operation of dividing classes of the pixels is performed (S34).

In order to generate the prediction data corresponding to the prediction block, the pixel value of each pixel included in the prediction block and the offset value that is set according to the class to which the corresponding pixel belongs are added to each other (S35). A restored image is generated based on the addition result (S36). In addition, residue data information included in the bitstream may be added to result of adding the he pixel value of each pixel included in the prediction block and the offset value that is set according to the class to which the corresponding pixel belongs. A restored image is generated based on both addition results. The restored image may be generated by using the prediction data to which the offset value is applied and the information about the differential value included in the bitstream.

FIG. 17 is a block diagram of an application processor 600 including an encoding apparatus and/or a decoding apparatus according to an example embodiment of the present inventive concepts, for example the encoding apparatus of FIGS. 1, 3 and/or 4 and/or the decoding apparatus of FIGS. 2 and 14. The application processor 600 of FIG. 17 may be realized in various forms, for example, the application processor 600 may be configured as a system on chip (SoC). An SoC may be configured by integrating a system having various functions on a semiconductor chip, and a plurality of intellectual properties (IPs) may be integrated in the SoC. Each of the IPs may perform a certain function of its own in the SoC.

The application processor 600 may include various IPs, for example, as illustrated in FIG. 17, the application processor 600 may include a multilevel interconnect bus 610 as a system bus, and a central processing unit (CPU) 620, a multimedia unit 630, a memory device 640, and a peripheral circuit 650 that are connected to the interconnect bus 610.

The interconnect bus 610 may be configured as a bus to which a protocol having a predetermined standard bus regulation is applied. For example, the standard bus regulation may be Advanced microcontroller bus architecture (AMBA) of ARM, Inc. The AMBA protocol may include bus types such as advanced high-performance bus (AHB), advanced peripheral bus (APB), advanced eXtensible interface (AXI), AXI4, AXI coherency extensions (ACE), and the like. From among the above bus types, AXI is an interface protocol between the IPs, and provides a multiple outstanding address function and a data interleaving function. In addition, other types of protocols such as uNetwork of SONICs Inc., CoreConnect of IBM Inc., open core protocol of OCP-IP, or the like may be applied to the interconnect bus 610.

In addition, each of the IPs illustrated in FIG. 17 may act as a functional block performing operations of its own. For example, the CPU 620 may correspond to a master IP, and may control overall operations of the application processor 600. Also, the multimedia unit 630 may include the video encoding apparatus and/or the video decoding apparatus according to the example embodiments of the present inventive concepts, for example, the multimedia unit 630 may include the video encoding apparatus of FIGS. 1, 3 and/or 4 and/or the video decoding apparatus of FIGS. 2 and 14. In addition, the multimedia unit 630 may perform an encoding/decoding operations by using the method according to one of the above example embodiments in order to encode/decode a video, for example, the method of FIGS. 12, 13 and 16. The memory device 640 is a memory for temporarily storing information about the operations of the application processor 600, and may include, for example, a dynamic random access memory (DRAM). Also, the peripheral circuit 650 may include various interface units for interfacing with external devices, and may include various peripheral devices for realizing the performance of the application processor 600. For example, the peripheral circuit 650 may include another memory, besides the DRAM, or may include a unit for accessing an external storage.

The application processor 600 may be mounted in various terminals such as a mobile apparatus to perform as a main processor. The multimedia unit 630 may provide original image data by decoding an encoded bitstream provided to the mobile apparatus, and may provide a bitstream by encoding the original image data in the mobile apparatus. As described above, the multimedia unit 630 may perform the motion estimation and the motion compensation operations when performing the data encoding/decoding operations, and may set offset values that are different according to the regions in the prediction block by dividing the regions in the prediction block when performing the motion estimation and compensation.

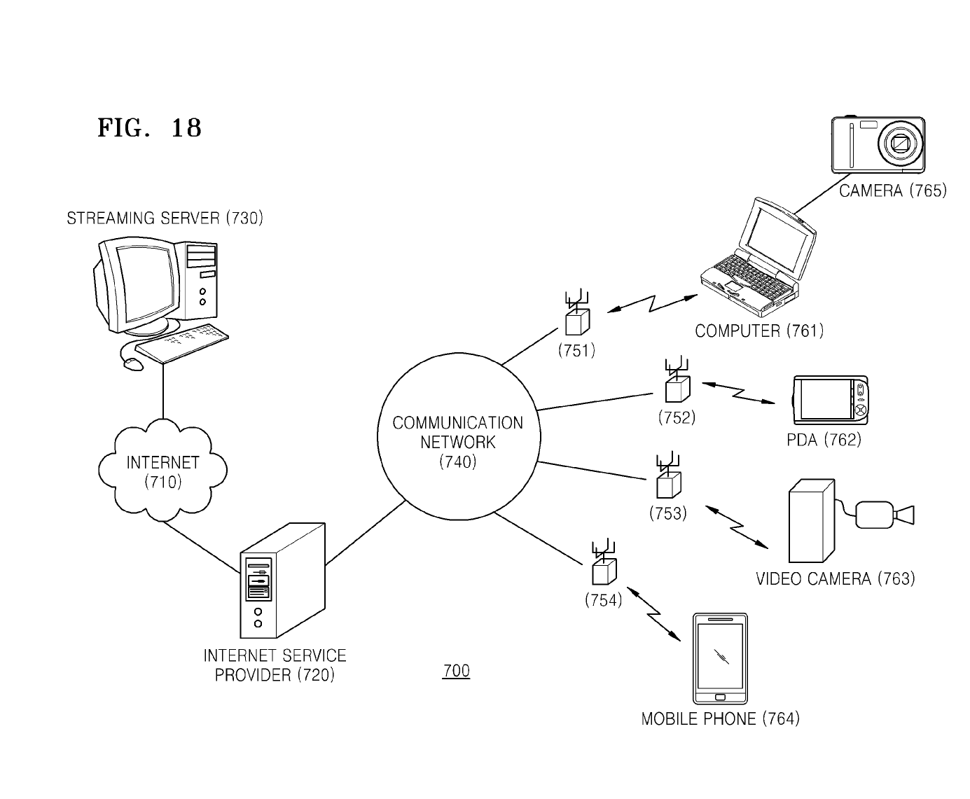

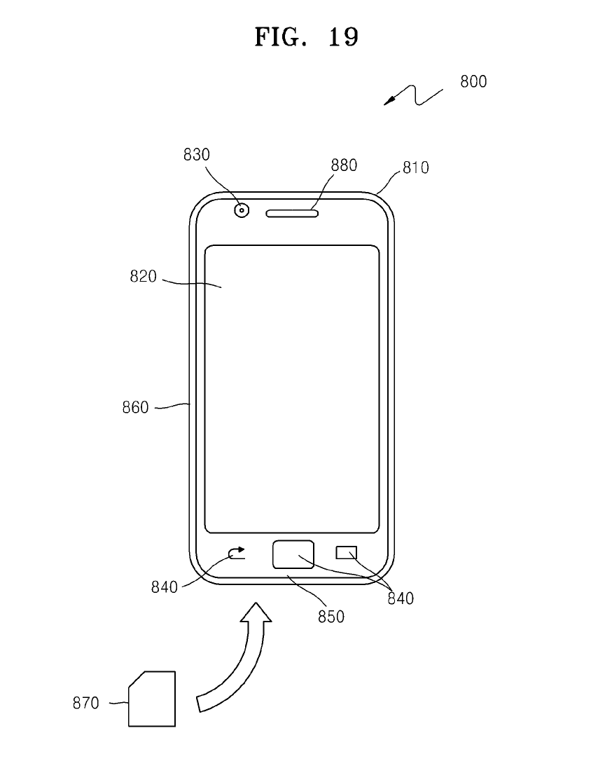

A system to which the video encoding and decoding methods according to the above example embodiments of the present inventive concepts are applied will be described below. FIG. 18 is a schematic diagram of a configuration of a content supply system 700 for providing a content distribution service according to an example embodiment of the present inventive concepts. A service area of a communication system is divided into a plurality of cells having predetermined sizes, and the cells include wireless base stations 751 to 754 as base stations.

The content supply system 700 may include a plurality of independent devices. For example, the content supply system 700 may include independent devices such as a computer 761, a personal digital assistant (PDA) 762, a camera 765, a video camera 763 and a mobile phone 764 may be connected to the Internet 710 via an interne service provider 720, a communication network 740, and the wireless base stations 751-754. However, the content supply system 700 is not limited to the structure illustrated in FIG. 18, and various devices may be selectively connected to the content supply system. The independent devices may be directly connected to the communication network 740 without using the wireless base stations 751-754. The video camera 763 is an imaging device capturing video images, for example, a digital video camera. The mobile phone 764 may adopt at least one communication type from among various protocols such as personal digital communications (PDC), code division multiple access (CDMA), wideband code division multiple access (W-CDMA), global system for mobile communications (GSM), personal handyphone system (PHS), or the like.

The video camera 763 may be connected to a streaming server 730 via the wireless base station 753 and the communication network 740. The streaming server 730 may stream content provided by a user by using the video camera 763 in a real-time broadcasting. The content transmitted from the video camera 763 may be encoded by the video camera 763 or the streaming server 730. Video data captured by the video camera 763 may be transmitted to the streaming server 730 via the computer 761.

Video data captured by the camera 765 also may be transmitted to the streaming server 730 via the computer 761. The camera 765 is an imaging device capable of capturing still images and video images, for example, a digital camera. The video data transmitted from the camera 765 may be encoded by the camera 765 or the computer 761. Software for encoding and decoding video may be stored in a computer-readable recording medium such as a compact disc (CD), a read only memory (ROM) disk, a floppy disk, a hard disk, a solid state drive (SSD), a memory card, or the like that the computer 761 may access. Also, if a video is captured by a camera mounted in the mobile phone 764, the video data may be transmitted from the mobile phone 764. The video data may be encoded by the video camera 763, the mobile phone 764, or a large scale integrated (LSI) circuit system mounted in the camera 765.

In the content supply system 700 according to the present example embodiment, when recording content such as a concert, content recorded by a user using the video camera 763, the camera 765, the mobile phone 764, or another imaging device is encoded, and then, is transmitted to the streaming server 730. The streaming server 730 may transfer the content data to other clients requesting the content data through streaming. The clients are devices for decoding the encoded content data, for example, the computer 761, the PDA 762, the video camera 763, or the mobile phone 764. Therefore, the content supply system 700 enables the clients to receive the encoded content data and to reproduce the content data. The content supply system 600 enables the clients receiving the encoded content data to decode and reproduce the content data in real-time, so as to perform personal broadcasting. For the encoding and decoding operations of the above devices, the encoding and decoding apparatuses according to the example embodiments of the present inventive concepts may be mounted in devices, for example, the application processor 600 (or SoC) illustrated in FIG. 17 may be mounted in the devices.

FIG. 19 is a diagram showing an example of a mobile terminal 800 in which a video decoding apparatus, for example, the decoding apparatus of FIGS. 2 and 14, according to an example embodiment of the present inventive concepts is mounted. The mobile terminal 800 of FIG. 19 may correspond to the mobile phone 764 illustrated in FIG. 18, and the mobile terminal 800 may include the application processor 600 illustrated in FIG. 17. The mobile terminal 800 may be a smartphone capable of changing or extending a lot of functions through application programs. The mobile terminal 800 includes an internal antenna 810 for exchanging a radio frequency (RF) signal with a wireless base station, and a display screen 820 such as a liquid crystal display (LCD) or an organic light-emitting diode (OLED) screen for displaying images captured by a camera 830 or images received by the internal antenna 810 and decoded. The mobile terminal 800 may include a manipulation panel 840 including a control button and a touch panel. If the display screen 820 is a touch screen, the manipulation panel 840 may further include a touch sensor panel of the display screen 820. The mobile terminal 800 includes a speaker 880 or another type of sound output unit for outputting voice and sound, and a microphone 850 or another type of sound input unit for inputting voice and sound. The mobile terminal 800 may further include the camera 830 such as a charge-coupled device (CCD) camera for capturing video and still images. Also, the mobile terminal 800 may include a storage medium 870 for storing encoded or decoded data such as video or still images captured by the camera 830, transmitted via E-mail, or acquired from other media, and a slot 860 for mounting the storage medium 870 in the mobile terminal 800. The storage medium 870 may be a flash memory such as a secure digital (SD) card or an electrically erasable and programmable read only memory (EEPROM) built in a plastic case.

While the inventive concepts have been particularly shown and described with reference to example embodiments thereof, it will be understood that various changes in form and details may be made therein without departing from the spirit and scope of the following claims.

1. A video encoding method comprising:
detecting properties of pixels included in a prediction block;
dividing the prediction block into at least two regions according to a result of detecting the properties of the pixels;
calculating offset values respectively for the at least two regions, according to a result of dividing the prediction block; and
generating an offset prediction block by applying the offset values calculated respectively for the at least two regions to pixel values of the pixels in the prediction block.

2. The video encoding method of claim 1, further comprising performing an interpolation filtering operation on integer pixel values in order to generate a prediction block of a sub-pixel unit in addition to the prediction block of an integer pixel unit.

3. The video encoding method of claim 1, wherein the detecting of the properties of the pixels comprises detecting at least one of a brightness and an edge characteristic of each of the pixels included in the prediction block.

4. The video encoding method of claim 1, wherein the dividing of the prediction block into the at least two regions comprises:
classifying classes to which the pixels included in the prediction block belong according to the properties of the pixels; and
setting pixels that belong to the same class or similar classes as a region of the at least two regions according to a result of classifying the classes.

5. The video encoding method of claim 1, wherein the prediction block comprises a first pixel included in a first region and a second pixel included in a second region, and the generating of the offset prediction block comprises adding a first offset value to the first pixel and adding a second offset value to the second pixel.

6. The video encoding method of claim 1, wherein the prediction block comprises first through nth regions (here, n is an integer equal to or greater than 2), and the calculating of the offset values comprises calculating first through nth offset values corresponding to the first through nth regions, respectively.

7. The video encoding method of claim 6, wherein the offset prediction block is generated by adding the first through nth offset values respectively to the pixels included in the first through nth regions, and the video encoding method further comprises:
calculating a difference value between a pixel value of an original image and a pixel value of the offset prediction block; and
performing a transformation operation by using a result of calculating the difference value.

8. The video encoding method of claim 1, further comprising performing motion estimation by using a current frame and a reference frame, in order to generate the prediction block.

9.-17. (canceled)

18. A video decoding apparatus performing a decoding operation after receiving a bitstream, the video decoding apparatus comprising a motion compensation unit comprising:
a prediction block generator for generating a prediction block based on a motion vector included in the bitstream;
a class divider for dividing the prediction block into a plurality of regions according to properties of pixels included in the prediction block; and
a calculator for generating a motion compensation result through calculation processes using a plurality of offset values included in the bitstream and the pixels included in the prediction block.

19. The video decoding apparatus of claim 18, wherein the class divider divides classes to which each of the pixels is included based on at least one of brightness levels and edge category characteristics of the pixels included in the prediction block.

20. The video decoding apparatus of claim 18, wherein the motion compensation unit further comprises an offset value extractor for parsing the plurality of offset values included in the bitstream.

21. The video decoding apparatus of claim 18, wherein the calculator adds values of the pixels included in the prediction block and offset values that are different from each other according to the plurality of regions in which the pixels are included.

22. An application processor comprising the video decoding apparatus of claim 18.

23.-25. (canceled)

26. A motion compensation method comprising:
classifying a prediction block into a plurality of regions according to properties of pixels of the prediction block;
calculating a plurality of offset values for each of the plurality of regions,
wherein the offset values of at least two of the plurality of offset values are different from each other.

27. The motion compensation method of claim 26, wherein the classifying the prediction block into a plurality of regions comprises classifying the prediction block into two or more regions according to at least one of brightness levels and edge categories of the pixels.

28. The motion compensation method of claim 26, wherein the classifying of the prediction block into the plurality of regions comprises:
classifying classes to which the pixels included in the prediction block belong according to the properties of the pixels; and
setting pixels that belong to the same class or similar classes as a region of the plurality of regions according to a result of classifying the classes

29. The motion compensation method of claim 26, further comprising calculating an offset prediction block by adding values of the pixels included in the plurality of regions to the offset values corresponding to the plurality of regions.

30. The motion compensation method of claim 29, wherein the prediction block comprises a first pixel included in a first region and a second pixel included in a second region, and the calculating the offset prediction block comprises adding a first offset value to the first pixel and adding a second offset value to the second pixel.

31. The video encoding method of claim 26, wherein the prediction block comprises first through nth regions (here, n is an integer equal to or greater than 2), and the calculating of the plurality of offset values comprises calculating first through nth offset values corresponding to the first through nth regions, respectively.
